(19) United States
(12) Patent Application Publication
(10) Pub. No.: US 2012/0049094 A1
(43) Pub. Date: Mar. 1, 2012

(54) PIPE FLOW BLOCKER SYSTEM

(76) Inventor: KAMYAR MOLAVI, The Woodlands, TX (US)

(21) Appl. No.: 13/212,878

(22) Filed: Aug. 18, 2011

Related U.S. Application Data
(60) Provisional application No. 61/377,845, filed on Aug. 27, 2010.

(51) Int. Cl. F16K 7/04

(52) U.S. Cl. 251/4

(57) ABSTRACT

A pipe flow blocker system, is disclosed. The pipe flow blocker may include a wall configured to be pressed inward and crimp a section of piping, thus sealing off a section of piping and inhibiting fluid from flowing through and out from a leak in the piping.

### CROSS-REFERENCE TO RELATED APPLICATION

This application claims the benefit of priority of U.S. provisional patent application No. 61/377,845, filed, Aug. 20, 2010, the contents of which are herein incorporated by reference.

### BACKGROUND OF THE INVENTION

The present invention generally relates to plumbing, and more particularly, to a pipe flow blocker system.

Current piping systems may be difficult to repair once compromised and a leak is sprung. Sections of piping may be part of an extended length of piping that once damaged, fluid can flow from the leak from before and aft the compromised section. Adding to the complexity of repair is that some piping is underwater and the fluid, for example, oil, may flow undeterred. Approaches to fixing the damaged piping include replacing the length of the line or shutting off the fluid source. However, sometimes closing off the source is near impossible. Thus, for example, in the case of underwater oil or gas delivery pipelines, one approach to fix a leak is to cap a line, which may require cutting or welding sections of the pipe. This may be dangerous when the fluid is combustible.

As can be seen, there is a need for a system that blocks flow through a pipe in a removable section.

### SUMMARY OF THE INVENTION

In one aspect of the present invention, a flow blacker system comprises a compressible pipe section; a hollow housing configured to surround the pipe section; and a wall of the housing including first and second ends.

In another aspect of the present invention, a modular pipe system comprises a pipe; a housing surrounding the pipe; and a sealant disposed between the housing and the piping.

These and other features, aspects and advantages of the present invention will become better understood with reference to the following drawings, description and claims.

### BRIEF DESCRIPTION OF THE DRAWINGS

FIG. 1 is a side view of a submerged piping system according an exemplary embodiment of the present invention;

FIG. 2 is a perspective end view of a pipe flow blocker system according to an exemplary embodiment of the present invention;

FIG. 3 is a cross sectional end view of the pipe flow blocker system taken along line 3-3 of FIG. 2;

FIG. 4 is a cross sectional end view of the pipe flow blocker system in a crimped state;

FIG. 5 is a cross sectional side view of the pipe flow blocker system taken along the line 5-5 of FIG. 3;

FIG. 6 is a cross sectional side view of the pipe flow blocker system of FIG. 5 in a crimped state;

FIG. 7 is a cross sectional side view of a pipe flow blocker system according to an exemplary embodiment of the present invention;

FIG. 8 is a perspective end view of a pipe flow blocker system according to an exemplary embodiment of the present invention;

FIG. 9 is a perspective front view of a crimper with a swinging bottom clamp for use with a pipe flow blocker system according to an exemplary embodiment of the present invention; and

FIG. 10 is a perspective front view of the crimper of FIG. 10 with the bottom clamp closed prior to crimping a piece of pipe.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a system of modular or replaceable section of piping adaptable to terminate leaks. Aspects of the present invention may provide a flow blocker of fluid in piping that is upstream from a leak. In one aspect, a section of the piping is compressible into a crimp sealing the fluid within the piping, yet may provide structural support around the crimped section maintaining a structural integrity of the remaining piping without relying on moving parts. Furthermore, aspects of the following disclosure may be suitable to diverse piping applications. For example, aspects of the present invention may be used in oil, gas, water, or blood/drug delivery systems.

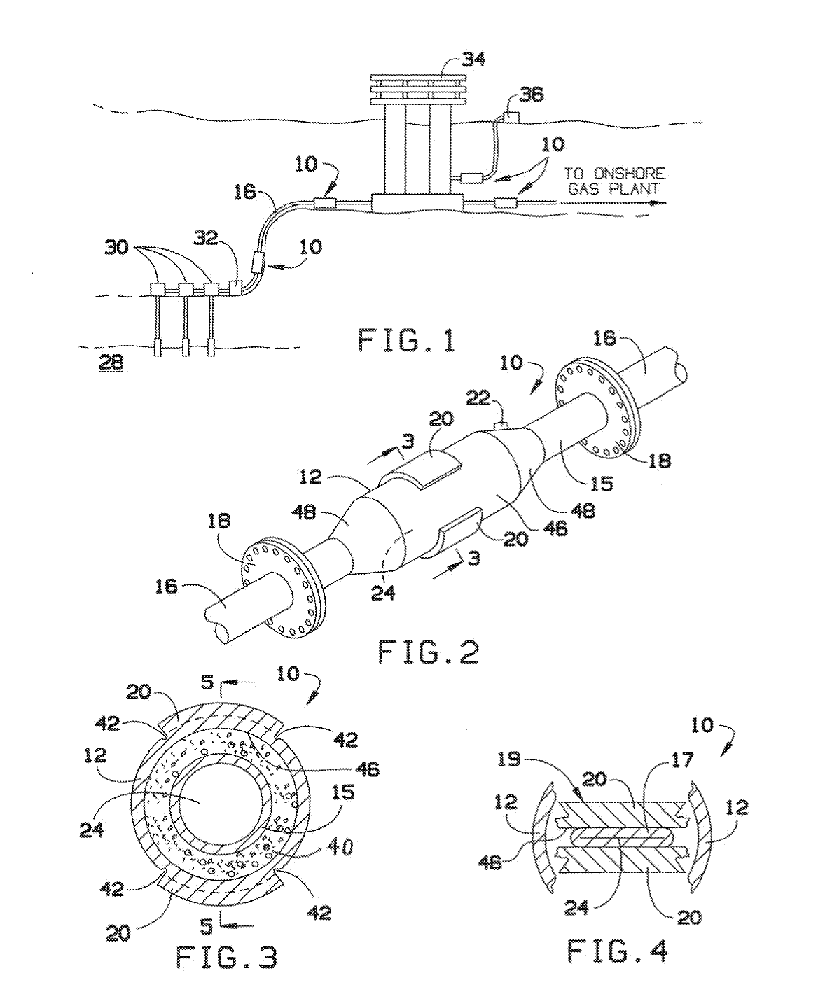

Referring to FIG. 1, an exemplary environment using a flow blocker system 10 is illustrated according to an exemplary embodiment of the present invention. A fluid, for example, oil or natural gas may be transported through a pipeline 16. The pipeline 16, also referred to as pipe section 16, or piping 16, may be offshore connected to an offshore rig 34, one or more oil wells 30 withdrawing oil from beneath an underwater field 28, and an onshore plant (not shown). Sections of the pipeline 16 may be submerged underwater. The pipeline 16 may include a subsea manifold 32 located proximate the wells 30. The pipeline 16 may also include a loading buoy 36 that may be semi-submerged or floating atop water. In one aspect, the marine environment may be protected by uncontrolled compromises in the pipeline 16 by employing multiple flow blocker systems 10 along various points of the pipeline. A compromise in the pipeline 16 may issue forth unchecked fluid flow, e.g. oil contaminating the surrounding waters. Use of the flow blocker system 10 may stem the oil flow by securely crimping off a section of the pipeline 16 before and/or aft a leak (not shown) without creating further compromises in pipeline.

Referring now to FIGS. 2-4, a flow blocker system 10 includes a compressible pipe section 15 connected intermediately between two sections of pipeline 16. A housing 12 surrounds the pipe section 15 and may be spaced therefrom. The pipe section 15 may be hollow and containment area 24 may be defined as a length of the pipe section 15 crimped off from a remainder of un-crimped portions. The pipe section 15 may be made from, for example, metal alloys that allow the pipe section 15 to become collapsible under pressure without causing cracks or leakage. The housing 12 may be hollow and include flared ends 48. The housing 12 may be rigid and also include a compressible wall 46 with one or more notches 42 positioned under the perimeter edges of the collar 20. The notches 42 may be disposed to provide a smaller cross-section between an outer and inner diameter of the housing 12. It will be understood that in FIG. 2, the notches 42 are obstructed from view by the overlying collar 20. The collar 20 may be placed around the wall 46. The collar 20 may be a full ring-shaped element, a partially ring-shaped element, or may include two opposing clamp portions as shown, disposed on opposite sides of the housing 12. The collar 20 may extend width-wise, transversely the length of the housing 12 or just along a portion of the housing wall 46.

The materials employed in exemplary embodiments of the housing 12 and housing wall 46 may depend on the application of use. For example, in exemplary embodiments it may be desirable to provide a break in the housing wall 46, thus generally rigid materials may be employed. However, in exemplary embodiments where compression without breakage is sufficient, compressible materials may be suitable. The housing wall 46 and collar 20 may be made from various alloys. For example, titanium alloys, or high nickel content alloys may be used in exemplary embodiments adapted for use in oil or gas delivery systems. In exemplary embodiments adapted for use in municipal water systems, examples of materials employed may include copper, polyethylene or vinyl chloride. In other exemplary embodiments adapted for use in medical applications, for example, fluid drug dispensing or blood delivery systems, polymeric or elastomeric materials may be used. The flow blocker system 10 may also include a cavity, defined by the spacing between the housing 12 and the pipe section 15. In an aspect of the present invention, a filler 40, for example, a sealant, foam, or grease may be inserted into the cavity between housing 12 and pipe section 15 through port 22. The filler 40 may provide further protection of the pipe section 15. The filler 40 may include material allowing it to adhere to the inner walls of the housing 12 and the outer walls of the pipe section 15, thus protecting each from corrosion.

Referring to FIGS. 4, 9, and 10, in one exemplary method of use, fluid flow may be impeded by using a crimper 300 to press against the collar 20. For sake of illustration in FIG. 10, a generic pipe section PS is shown as representing exemplary embodiments of the flow blocker system 10. The crimper 300 may include an upper clamp 310 and a lower clamp 320 slidably engagable to one another along a set of hydraulic pistons 335. The pistons 335 may extend from a set of cylinders 330 when the upper clamp 310 is in an open position. The lower clamp 320 may include a vertical groove 325 in linear disposition with one of the pistons 335. The lower clamp 320 may be adapted to pivot around one of the pistons 335 so that the lower clamp 320 may swing open to allow the pipe section PS to be positioned under the upper clamp 310. When the pipe section PS is in position, the lower clamp 320 may be swung into a locked position engaging the groove 325 onto the piston 335.

The crimper 300 may be placed on the collar 20. As the crimper 300 presses the housing 12 inward, collar 20 may break away from the housing 12. Thus, the crimper 300 and the collar 20 press against pipe section 15. The housing wall 46 and, in some cases, the collar 20, may become a press-fit clamp 19 as a portion of the pipe section 15 is transformed into a crimped pipe section 17 thus, providing the containment area 24. In another aspect, the portion of the housing 12 that has not been broken away may remain intact. The crimped pipe section 17, while structurally robust in a localized area, may be considered by some, a weak point along the overall length of the pipeline 16. Thus, while the broken away portion of the housing wall 46 may contribute to clamping down on a leak, the remaining housing 12 may provide structural integrity bridging the adjacent pipeline sections 16.

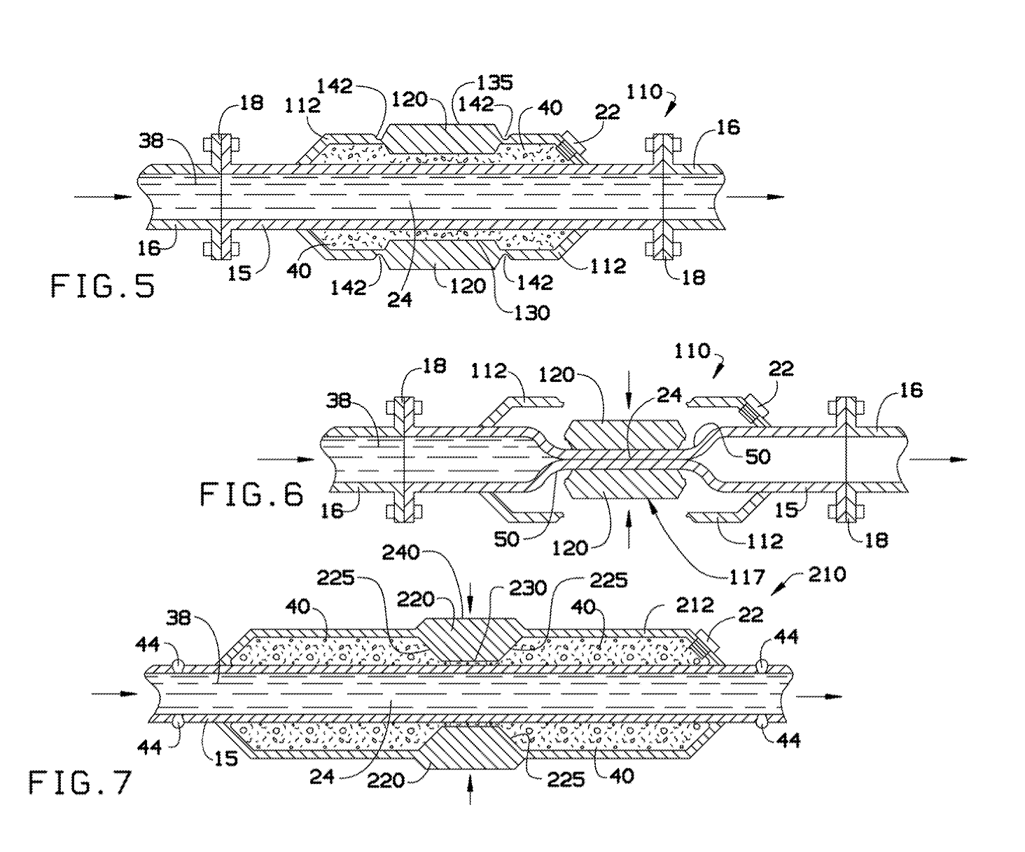

Referring to FIGS. 5-6, another exemplary embodiment of a flow blocker system 110 is shown. Flow blocker system 110 is similar to system 10 except that a collar 120 may be integrated into housing 112. In one aspect the housing 112 may also include a break away portion configured to seal off fluid 38 from one pipe section 16 from an adjacent pipe section 16. The collar 120 may employ relatively heavier and rigid metal. The collar 120 may include an inner diameter wall 130 with substantially similar axial width as an outer diameter wall 135. The inner diameter wall 130 may project inward into the cavity between the housing 112 and the pipe section 15. The housing 112 may include notches 142 disposed, for example, circumferentially around the housing 112. The notches 142 may be positioned at one or both ends of the collar 120. Referring to FIG. 6, as the housing 112 is crushed, the collar 120 may break away from the housing 112 along notches 142. The relatively thicker distance between inner and outer diameter walls 130 and 135 may provide more weight in creating a press-fit clamp 117 around containment area 24 with pinched ends 50. Similar to the embodiment described in FIGS. 2-4, the housing 112 may include an unbroken portion that remains intact providing structural integrity bridging adjacent pipeline sections 16. For sake of illustration, FIG. 6 is shown without filler 40.

Referring to FIG. 7, another exemplary embodiment of a flow blocker system 210 is shown using a housing 212. The flow blocker system 210 is similar to the system 10 except that the flow blocker system 210 may also include a collar 220. The flow blacker system 220 may be useful in high pressure, low flow applications; for example, when employing smaller radius pipe sections 15. In one aspect, the flow blocker system 220 may be generally flexible so that its elements do not break away. For example, the collar 220 may be generally heftier and integrated into the housing 212. The housing 212 may be made from generally flexible or malleable materials. The collar 220 may include a diamond-shaped profile when viewed from a cross-sectional view. For example, the collar 220 may include inwardly tapering diameter sidewalls 225 extending through the housing 212 into the cavity between the housing 212 and the pipe section 15. An inner diameter wall 230 connected, between the sidewalls 225 may be of shorter width than an outer diameter wall 240 disposed outside the housing 212. The inner diameter wall 230 may be positioned substantially close to the pipe section 15 in exemplary embodiments adapted for oil or gas delivery, thus providing increased accuracy in crushing the pipe section 15. The wider outer diameter wall 240, when pressed, may be configured to receive applied pressure over a wider distributed area than the inner diameter wall 230. Pressure applied to the collar 220 may deliver a more concentrated pressure through the inner diameter wall 230 to the pipe section 15. The housing 212 may be drawn inward as the collar 220 squeezes the pipe section 15. Thus, the structural integrity of the pipeline 16 may be held intact from adjacent pipeline sections 16 through the pipe section 15.

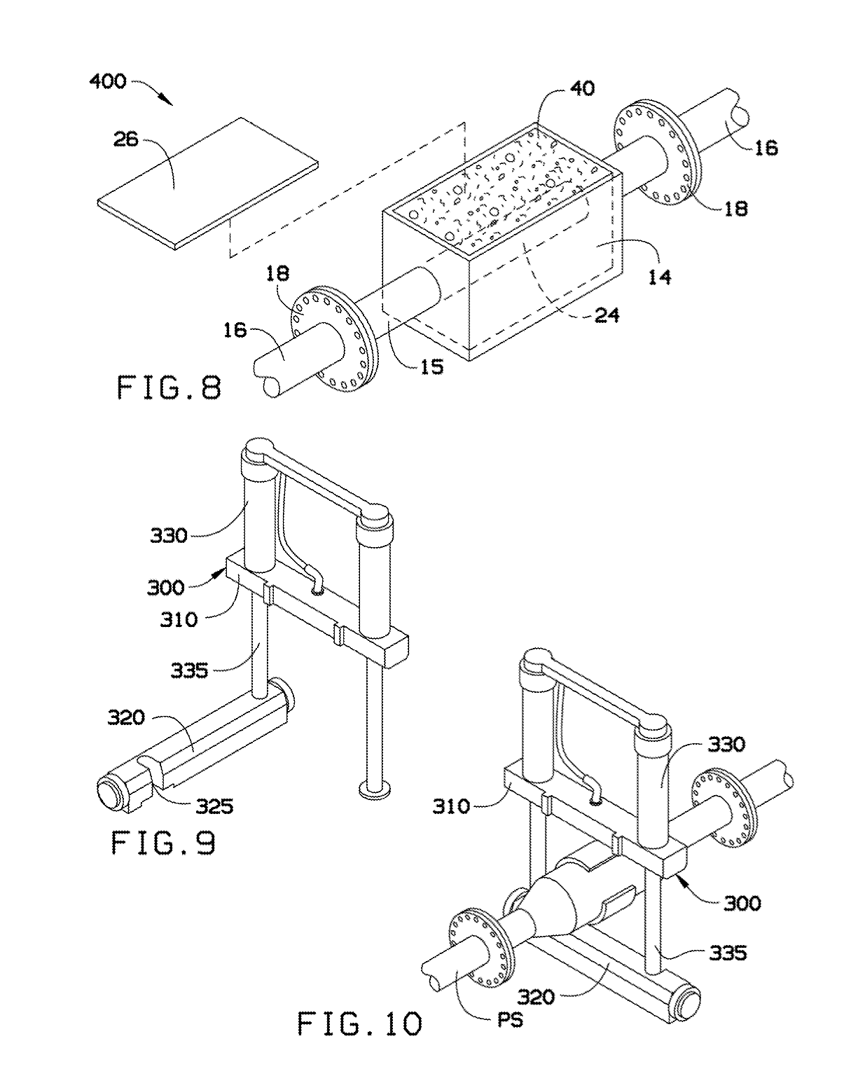

Referring to FIG. 8, in another exemplary embodiment, a flow blocker system 400 is shown, similar to the system 10 except that instead of a cylindrical housing 12, a boxed housing 14 may be disposed around the pipe section 15. The box housing 14 may be replaceably filled with filler 40 and encapsulated by a cover 26. Similar to the embodiments described above, portions of the housing 14 may be pressed around and clamped onto the pipe section 15 sealing the pipe section 15 while remaining, intact portions of the housing 14 may continue to provide structural integrity to the pipeline 16.

Referring to FIGS. 2 and 5-8, it may be appreciated that in one aspect, the flow blocker systems 10; 110; 210; and 400 are modular or can be configured as a replaceable section of a larger piping system. The flow blocker systems 10; 110; 210; and 400 are configurable in employing diverse types of connections depending on the application of use. Yet, regardless of the connection method to adjacent sections of piping, aspects of the present invention may provide an isolated section of piping sealing a section of piping including the systems 10; 110; 210; or 400 from surrounding piping. Thus, the flow blocker system 10; 110; 210; or 400 may be disconnected from the remaining piping when the overall fluid flow is in a contained state. For example, in exemplary embodiments that adapt the systems 10; 110; 210; and 400 for use in oil or gas delivery systems, connection to adjacent pipeline 16 sections may be made via, for example, welded mounting flanges 18 on ends of the pipe section 15 as shown in FIGS. 2, 5, 6, and 8. Another exemplary embodiment may employ a connection to adjacent pipeline sections 16 via spot welds 44 on ends of the pipe section 15 as shown in FIG. 7.

It should be understood, of course, that the foregoing relates to exemplary embodiments of the invention and that modifications may be made without departing from the spirit and scope of the invention as set forth in the following claims.

What is claimed is:

1. A flow blocker system, comprising:
a compressible pipe section;
a hollow housing configured to surround the pipe section; and
a wall of the housing including first and second ends.

2. The system of claim 1, further comprising a notch disposed in the wall.

3. The system of claim 1, further comprising a collar configured to surround at least a portion of the wall.

4. The system of claim 3, further comprising one or more notches disposed under one or more edges of the collar.

5. The system of claim 3 wherein the housing is adapted to break off around the portion of the wall.

6. The system of claim 1, wherein the housing is adapted to be spaced from the pipe section.

7. The system of claim 5 further comprising a filler disposed within a cavity between the housing and the pipe section.

8. The system of claim 1, wherein the collar is disposed intermediate the first and second wall ends.

9. A modular pipe system, comprising:
a pipe;
a housing surrounding the pipe; and
a sealant disposed between the housing and the piping.

10. The system of claim 9, wherein the housing includes first and second wall ends that are flared.

11. The system of claim 9, further comprising a breakable section of the housing adapted to clamp the pipe during a crimping of the breakable section of the housing.

12. The system of claim 11, further comprising a pair of clamps disposed on opposing sides of the housing breakable section.

13. The system of claim 12 wherein the clamps are integrated into the housing breakable section.

14. The system of claim 13 wherein the pair of clamps include an inner diameter wall and an outer diameter wall, wherein the inner diameter wall includes a width shorter than a width of the outer diameter wall.

15. The system of claim 11 wherein ends of the pipe are adapted to modularly disconnect from adjacent pipes.
